(19) United States
(12) Patent Application Publication
(10) Pub. No.: US 2019/0357578 A1
(43) Pub. Date: Nov. 28, 2019

(54) COMPOSITION FOR ENHANCING MUSHROOM FLAVOR

(71) Applicant: TableMark Co., Ltd., Tokyo (JP)

(72) Inventors: Mayuka MATSUI, Tokyo (JP); Hiroyuki SANO, Tokyo (JP); Masataka OTA, Yokohama-shi (JP)

(73) Assignee: TableMark Co., Ltd., Tokyo (JP)

(21) Appl. No.: 16/476,802

(22) PCT Filed: Sep. 29, 2017
(86) PCT No.: PCT/JP2017/035641

§ 371 Date: Jul. 9, 2019

(30) Foreign Application Priority Data
Jan. 10, 2017 (JP) 2017-002034

(51) Int. Cl. A23L 27/23; A23L 31/15; A23L 27/21

(52) U.S. Cl. CPC A23L 27/235; A23V 2002/00; A23L 27/21; A23L 31/15

(57) ABSTRACT

The present invention relates to a composition for enhancing mushroom flavor and a method for enhancing mushroom flavor of a food or a beverage. The composition and the method of the present invention comprise a nucleic acid comprising guanylic acid and adenylic acid.

### TECHNICAL FIELD

The present invention relates to a composition for enhancing mushroom flavor and use thereof.

### BACKGROUND ART

In the food and beverage industry, if the flavor of a specific food material can be given to a food or a beverage by use of a seasoning (composition), the amount of the specific food material to be used can be reduced, and thus, this is favorable from the viewpoint of cost, convenience of cooking, and the like.

Findings about Taste Produced by Shiitakes

It has been reported that mushrooms comprise a large quantity of nucleic acid ingredients such as guanylic acid (GMP), adenylic acid (AMP), cytidylic acid (CMP), and uridylic acid (UMP). Eiyo to Shokuryo (in Japanese) (Nutrition and Food) Vol. 18 (1965) No. 4, p 290-294 (Non Patent Literature 1) discloses that umami was sensed in a fraction comprising 5′-GMP when sample solutions of ingredients contained in a shiitake-extracted liquid were fractioned and subsequently subjected to a sensory evaluation and that 5′-GMP was the main ingredient of umami from shiitakes. The Canners Journal Vol. 55 (1976) No. 2 p 104-118 (Non Patent Literature 2) discloses that freshly-picked mushrooms does not comprise 5′-GMP, but 5′-GMP, an umami ingredient, accumulates as a result of an enzyme action when the mushrooms are cooked or heat-treated during a food processing step.

Non Patent Literatures 1 and 2 disclose that among nucleic acid ingredients, GMP particularly contribute greatly as an umami ingredient. In contrast, adenylic acid (AMP) has little taste-producing properties and is known to produce taste only after being converted to inosinic acid (IMP), for example by an enzyme such as deaminase.

Findings about Yeast Extract

Various different yeast extracts are commercially available as an easy-to-use seasoning.

WO 88/05267 (Patent Literature 1) describes a method for manufacturing a natural yeast extract rich in 5′-GMP by heating an aqueous solution of raw yeast cells rich in RNA and allowing 5′-phosphodiesterase to act thereon, followed by either allowing or not allowing a deaminase to act thereon. Example 6 of Patent Literature 1 discloses that the yeast extract obtained by culturing Candida utilis strains and reacting the cells obtained after centrifugation with a protease and a ribonuclease (not with a deaminase) contained 12.5% by weight of 5′-GMP and had a strong shiitake-like taste.

Japanese Patent Laid-Open No. 2-79954 (Patent Literature 2) describes a method for manufacturing a natural yeast extract that contains 5′-IMP and 5′-GMP, which are manufactured from extract ingredients comprising ribonucleic acid within the yeast cell, and additionally a glutamate salt. In this literature, 5′-phosphodiesterase is allowed to act on the nucleic acid ingredient derived from the yeast cell and subsequently deaminase is allowed to act thereon. Consequently, RNA within the cell is decomposed into 5′-nucleotide, and furthermore, 5′-AMP, which is the decomposition product of RNA, is converted to 5′-IMP.

Japanese Patent Laid-Open No. 2000-37170 (Patent Literature 3) describes a sweetness-improving agent that comprises a substance extracted from yeast as an active ingredient (Claim 1).

Japanese Patent Laid-Open No. 2002-101846 (Patent Literature 4) describes a method for manufacturing a yeast extract with a high content of 5′-nucleotide that contains 5′-guanylic acid, 5′-adenylic acid, 5′-cytidylic acid, and 5′-uridylic acid, each in an amount of 10% or more (Claim 1). The yeast extract described in Patent Literature 4 has little yeast smell and is a yeast extract that contains a large quantity of taste-producing 5′-nucleotide (Paragraph 0001 of Patent Literature 4).

Japanese Patent Laid-Open No. 2004-313178 (Patent Literature 5) describes an additive to feed for mother pigs that comprises a yeast extract containing a ribonucleic acid and/or 5′-nucleotide as an active ingredient (Claim 4). Japanese Patent Laid-Open No. 2006-129834 (Patent Literature 6) describes a yeast extract with a high content of 5′-ribonucleotide that comprises 5′-inosinic acid and 5′-guanylic acid (in a sodium salt hydrate form) in a total amount of 24% or more by weight, a peptide in an amount of 20% or more by weight, and the peptide and a free amino acid in a total amount of 28% or more by weight (Claim 1).

Japanese Patent Laid-Open No. 2007-49989 (Patent Literature 7) describes a yeast extract that contains a free amino acid in an amount of 25% or more by weight and nucleic acid-based taste-producing ingredients in a total amount of 2% or more by weight (Claim 1). It is disclosed that this yeast extract is a yeast extract in which rapidly-developing umami (so called initial taste) and long-lasting strong umami (so called aftertaste) are balanced and that can give very strong umami to a food and a beverage due to a synergistic effect between the free amino acid, and 5′-inosinic acid and 5′-guanylic acid (Paragraph 0011 of Patent Literature 7).

Japanese Patent Laid-Open No. 2009-39019 (Patent Literature 8) describes a yeast extract that contains 20% or more by weight of a pyrimidine nucleotide (5′-uridylic acid, 5′-cytidylic acid, and salts thereof) and contains less than 5% by weight of a purine nucleotide (5′-guanylic acid, 5′-inosinic acid, 5′-adenylic acid, and salts thereof) (Claim 1). It is disclosed that the yeast extract of Patent Literature 8 is useful for taking a proper quantity of the pyrimidine nucleotide, which improves metabolism (Paragraphs 0002 and 0004 of Patent Literature 8).

As described above, a variety of yeast extracts have been studied, and a yeast extract with a high nucleic acid content, which contains a large quantity of inosinic acid (IMP) converted from guanylic acid (GMP) or adenylic acid (AMP) using an enzyme, is known as a seasoning.

### CITATION LIST

### Patent Literature

PTL 1: WO 88/05267
PTL 2: Japanese Patent Laid-Open No. 2-79954
PTL 3: Japanese Patent Laid-Open No. 2000-37170
PTL 4: Japanese Patent Laid-Open No. 2002-101846
PTL 5: Japanese Patent Laid-Open No. 2004-313178
PTL 6: Japanese Patent Laid-Open No. 2006-129834
PTL 7: Japanese Patent Laid-Open No. 2007-49989
PTL 8: Japanese Patent Laid-Open No. 2009-39019

### Non Patent Literature

NPL 1: Eiyo to Shokuryo (in Japanese) (Nutrition and Food) Vol. 18 (1965) No. 4, p 290-294
NPL 2: The Canners Journal Vol. 55 (1976) No. 2 p 104-118

### SUMMARY OF INVENTION

### Technical Problem

The present inventors used the yeast extract with a high nucleic acid content to examine taste produced thereby. As a result of a dedicated examination, the present inventors have discovered that mushroom flavor was enhanced by adding these yeast extracts in addition to a mushroom-extracted substance. Furthermore, the present inventors examined the ingredients comprised in these yeast extracts in detail and have found that the nucleic acid ingredients, guanylic acid (GMP) and adenylic acid (AMP) were mainly responsible for a mushroom flavor-enhancing action. Furthermore, the present inventors have found out that a free amino acid such as glutamic acid (Glu) and alanine (Ala) comprised in the yeast extract and an organic acid such as succinic acid further increases a mushroom flavor-enhancing effect.

An object of the present invention is to provide a composition for enhancing mushroom flavor.

Another object of the present invention is to provide a method for enhancing mushroom flavor.

Yet another object of the present invention is to provide a method for manufacturing a food or a beverage that has an enhanced mushroom flavor.

Still another object of the present invention is to provide use for enhancing mushroom flavor.

### Solution to Problem

The present invention includes, but is not limited to, the following embodiments.

### Embodiment 1

A composition for enhancing mushroom flavor, comprising a nucleic acid comprising guanylic acid and adenylic acid.

### Embodiment 2

A composition for enhancing mushroom flavor, comprising a nucleic acid comprising guanylic acid and adenylic acid and a free amino acid comprising glutamic acid and alanine.

### Embodiment 3

A composition for enhancing mushroom flavor, comprising a nucleic acid comprising guanylic acid and adenylic acid, a free amino acid comprising glutamic acid and alanine, and succinic acid.

### Embodiment 4

The composition for enhancing mushroom flavor according to any one of embodiments 1 to 3, wherein the composition is a yeast extract.

### Embodiment 5

The composition for enhancing mushroom flavor according to any one of embodiments 1 to 4, wherein the composition comprises a nucleic acid comprising 0.0004% by weight or more and less than 0.3% by weight of guanylic acid and 0.0001% by weight or more and less than 2% by weight of adenylic acid.

### Embodiment 6

The composition for enhancing mushroom flavor according to any one of embodiments 2 to 5, wherein the composition comprises a free amino acid comprising 0.00001% by weight or more and less than 2% by weight of glutamic acid and 0.00004% by weight or more and less than 0.8% by weight of alanine.

### Embodiment 7

The composition for enhancing mushroom flavor according to any one of embodiments 3 to 6, wherein the composition comprises 0.00002% by weight or more and less than 0.2% by weight of succinic acid.

### Embodiment 8

The composition for enhancing mushroom flavor according to any one of embodiments 1 to 7, wherein the mushroom is selected from the edible mushroom group consisting of shiitake (Lentinula edodes), button mushroom (Agaricus bisporus), porcino (Boletus spp.), enoki mushroom (Flammulina velutipes), white beech mushroom (Hypsizygus marmoreus), hon-shimeji (Lyophyllum shimeji), king oyster mushroom (Pleurotus eryngii), oyster mushroom (Pleurotus ostreatus), pine mushroom (Tricholoma matsutake), truffle (Tuber), and butterscotch mushroom (Pholiota microspora).

### Embodiment 9

The composition for enhancing mushroom flavor according to any one of embodiments 1 to 7, wherein the mushroom is selected from the edible mushroom group consisting of shiitake (Lentinula edodes), button mushroom (Agaricus bisporus), and porcino (Boletus spp.).

### Embodiment 10

The composition for enhancing mushroom flavor according to any one of embodiments 1 to 9, wherein the free amino acid further comprises one or more free amino acids selected from the group consisting of arginine, lysine, and cysteine.

### Embodiment 11

A method for enhancing mushroom flavor comprising adding a composition comprising a nucleic acid comprising guanylic acid and adenylic acid to a food or a beverage that comprises a mushroom or a mushroom-extracted substance.

### Embodiment 12

A method for enhancing mushroom flavor comprising adding a composition comprising a nucleic acid comprising guanylic acid and adenylic acid and a free amino acid comprising glutamic acid and alanine to a food or a beverage that comprises a mushroom or a mushroom-extracted substance.

### Embodiment 13

A method for enhancing mushroom flavor comprising adding a composition comprising a nucleic acid comprising guanylic acid and adenylic acid, a free amino acid comprising glutamic acid and alanine, and succinic acid to a food or a beverage that comprises a mushroom or a mushroom-extracted substance.

### Embodiment 14

A method according to any one of embodiments 11 to 13, wherein the composition is a yeast extract.

### Embodiment 15

A method according to any one of embodiments 11 to 14, wherein the composition comprises a nucleic acid comprising 0.0004% by weight or more and less than 0.3% by weight of guanylic acid and 0.0001% by weight or more and less than 2% by weight of adenylic acid.

### Embodiment 16

A method for manufacturing a food or a beverage that has an enhanced mushroom flavor, the method comprising adding a composition comprising a nucleic acid comprising guanylic acid and adenylic acid to a food or a beverage that comprises a mushroom or a mushroom-extracted substance.

### Embodiment 17

Use of a composition comprising a nucleic acid comprising guanylic acid and adenylic acid for enhancing mushroom flavor of a food or a beverage.

### Advantageous Effects of Invention

The composition of the present invention exerts a mushroom flavor-enhancing effect synergistically by adding the composition to a food or a beverage that comprises a mushroom or a mushroom-extracted substance.

### DESCRIPTION OF EMBODIMENTS

1. Composition for Enhancing Mushroom Flavor

In one aspect, the present invention relates to a composition for enhancing mushroom flavor.

(1) Nucleic Acid

The composition for enhancing mushroom flavor of the present invention comprises a nucleic acid comprising guanylic acid (GMP) and adenylic acid (AMP).

Without limitation, the final concentration of GMP in a state where the composition for enhancing mushroom flavor has been added to a food or a beverage is preferably about 0.0004% by weight or more and less than about 0.3% by weight, more preferably about 0.0008% by weight to about 0.2% by weight, even more preferably about 0.004% by weight to about 0.08% by weight, and most preferably about 0.008% by weight to about 0.04% by weight.

Without limitation, the final concentration of AMP in a state where the composition for enhancing mushroom flavor has been added to a food or a beverage is preferably about 0.0001% by weight or more and less than about 2% by weight, more preferably about 0.0008% by weight to about 0.8% by weight, and even more preferably about 0.008% by weight to about 0.1% by weight, about 0.008% by weight to about 0.08% by weight, or about 0.06% by weight to about 0.1% by weight.

In one embodiment of the present invention, the composition for enhancing mushroom flavor may comprise cytidylic acid (CMP) and/or uridylic acid (UMP). The contents of CMP and UMP are not particularly limited.

In one embodiment of the present invention, the composition for enhancing mushroom flavor does not comprise inosinic acid (IMP).

(2) Free Amino Acid

In one embodiment, the composition for enhancing mushroom flavor of the present invention preferably comprises a free amino acid comprising glutamic acid (Glu) and/or alanine (Ala) in addition to a nucleic acid ingredient. The mushroom flavor-enhancing effect of the composition of the present invention is further increased synergistically by comprising glutamic acid and/or alanine.

One embodiment of the present invention provides the composition for enhancing mushroom flavor, comprising a nucleic acid comprising guanylic acid and adenylic acid and a free amino acid comprising glutamic acid and alanine.

Without limitation, the final concentration of glutamic acid in a state where the composition for enhancing mushroom flavor has been added to a food or a beverage is preferably about 0.00001% by weight or more and less than about 2% by weight, more preferably about 0.0001% by weight to about 1% by weight, and even more preferably about 0.001% by weight to about 0.1% by weight. Without limitation, the final concentration of alanine is preferably about 0.00004% by weight or more and less than about 0.8% by weight, more preferably about 0.0004% by weight to about 0.4% by weight, and even more preferably about 0.004% by weight to about 0.04% by weight.

In one embodiment, the composition for enhancing mushroom flavor of the present invention may further comprise one or more free amino acids selected from the group consisting of arginine (Arg), lysine (Lys), and cysteine (Cys).

Without limitation, the final concentrations of arginine, lysine, and cysteine in a state where the above described composition has been added to a food or a beverage are as follows. The concentration of arginine is preferably about 0.00004% or more by weight and more preferably about 0.04% or more by weight. The concentration of lysine is preferably about 0.00008% or more by weight, more preferably about 0.008% or more by weight, and even more preferably about 0.02% or more by weight. The concentration of cysteine is preferably about 0.0000001% by weight or more and less than about 0.003% by weight and more preferably about 0.00001% by weight to about 0.001% by weight.

In one embodiment of the present invention, the composition for enhancing mushroom flavor may comprise a free amino acid such as isoleucine (Ile), leucine (Leu), phenylalanine (Phe), histidine (His), tyrosine (Tyr), valine (Val), and methionine (Met).

In one embodiment of the present invention, the composition for enhancing mushroom flavor may comprise another free amino acid such as γ-aminobutyric acid (GABA) and ornithine (Orn).

(3) Organic Acid

In one embodiment, the composition for enhancing mushroom flavor of the present invention preferably comprises succinic acid, which is an organic acid.

One embodiment of the present invention provides the composition for enhancing mushroom flavor, comprising a nucleic acid comprising guanylic acid and adenylic acid, a free amino acid comprising glutamic acid and alanine, and succinic acid.

Without limitation, the final concentration of succinic acid in a state where the composition for enhancing mushroom flavor has been added to a food or a beverage is preferably about 0.00002% by weight or more and less than about 0.2% by weight and more preferably about 0.0002% by weight to 0.02% by weight.

In one embodiment of the present invention, the composition for enhancing mushroom flavor may comprise an organic acid such as phosphoric acid, citric acid, malic acid, lactic acid, butyric acid, and proglutamic acid.

(4) Composition

In one embodiment, the composition for enhancing mushroom flavor of the present invention can be prepared by dissolving the above described ingredients, which are the nucleic acid and, if desired, the free amino acid and the organic acid, in a biologically acceptable solution. Ingredients insoluble in the solution may be ground and suspended. Any solution known as a solution for nucleic acid and the like may be used as the biologically acceptable solution. Examples of the solution include, but not limited to, distilled water, buffer, and saline.

In one embodiment, it is preferable that the composition for enhancing mushroom flavor of the present invention be adjusted to pH of about 5.5 to about 7.5, preferably pH of about 5.8 to 6.8, and more preferably pH of about 6.0 to 6.5. The composition of the present invention may comprise a peptide, inorganic salts, vitamins, saccharides, and fatty acids, in addition to the above described active ingredients, which are the nucleic acid, the free amino acid, and the organic acid.

In one embodiment, the composition for enhancing mushroom flavor of the present invention may also be derived from an organism such as a microorganism and a plant. For example, the composition of the present invention may be a yeast extract that comprises the above described ingredients. Without limitation, for example, HIMAX (registered trademark) AG (manufactured by Fuji Foods Corporation) can be used.

(5) Effect of Enhancing Mushroom Flavor

The composition of the present invention exerts the mushroom flavor-enhancing effect.

“Enhance mushroom flavor” means that mushroom savor (mushroom flavor) is increased (enhanced) when the composition of the present invention is added to a food or a beverage that originally comprises a mushroom, contains a mushroom extract, or has mushroom flavor, than when the composition is not added thereto.

In the present invention, the mushroom is not limited to a particular species. Without limitation, the mushroom is preferably selected from the edible mushroom group consisting of shiitake (Lentinula edodes), button mushroom (Agaricus bisporus), porcino (Boletus spp.), enoki mushroom (Flammulina velutipes), white beech mushroom (Hypsizygus marmoreus), hon-shimeji (Lyophyllum shimeji), king oyster mushroom (Pleurotus eryngii), oyster mushroom (Pleurotus ostreatus), pine mushroom (Tricholoma matsutake), truffle (Tuber), and butterscotch mushroom (Pholiota microspora). More preferably, the mushroom is selected from the edible mushroom group consisting of shiitake (Lentinula edodes), button mushroom (Agaricus bisporus), and porcino (Boletus spp.).

“Mushroom flavor” refers to a complicated taste characteristic of mushrooms, which includes umami and sweetness combined with subtle bitterness and astringency and refers to a flavor from which one strongly feels the existence of mushrooms when one eats, for example, a food having such flavor.

“Mushroom flavor is enhanced” means that such a complicated taste or flavor characteristic of mushrooms is sensed more strongly than when the composition of the present invention is not added. For example, the expression “mushroom flavor is enhanced” is used when, as a result of addition of the composition of the present invention, one can sense mushroom flavor equivalent to that of a food or a beverage that comprises 1.1 times, 1.15 times, 1.2 times, 1.5 times, 1.8 times, or 2 times more of the mushroom or the mushroom-extract. Alternatively, the expression “mushroom flavor is enhanced” in the present invention includes a case in which one cannot sense the mushroom or the mushroom-extract although a food or a beverage comprises a small amount of it and can sense the mushroom flavor only after addition of the composition of the present invention.

(6) Food or Beverage to which the Composition of the Present Invention is Added

In one embodiment, the composition for enhancing mushroom flavor of the present invention can be used by adding it to the food or the beverage that comprises the mushroom or the mushroom-extracted substance.

The food for which the composition of the present invention is used is not limited to a particular kind. The composition of the present invention can be used for any food in a Japanese meal, a Western meal, a Chinese meal, an Asian meal, an African meal, and the like, as long as the food comprises the mushroom or the mushroom-extracted substance. Examples of the meals include a food dressed with sauce, a stir-fried food, a simmered food, a rice dish, a soup dish, pasta sauce, a Japanese hot pot dish, soup, and stew.

The beverage for which the composition of the present invention is used is not limited to a particular kind, either. Examples of the beverage include a milk beverage, soup for drinking such as one in a canned form, soya milk, a sport drink, a fruit drink, alcohols, tea, and cocoa.

2. Method for Enhancing Mushroom Flavor

In one aspect, the present invention also relates to a method for enhancing mushroom flavor.

In one embodiment, the method of the present invention comprises adding a composition comprising a nucleic acid comprising guanylic acid and adenylic acid to a food or a beverage that comprises a mushroom or a mushroom-extracted substance.

In one embodiment, the method of the present invention also comprises adding a composition comprising a nucleic acid comprising guanylic acid and adenylic acid and a free amino acid comprising glutamic acid and alanine to a food or a beverage that comprises a mushroom or a mushroom-extracted substance.

Furthermore, in one embodiment, the method of the present invention comprises adding a composition comprising a nucleic acid comprising guanylic acid and adenylic acid, a free amino acid comprising glutamic acid and alanine, and succinic acid to a food or a beverage that comprises a mushroom or a mushroom-extracted substance.

The definition and description of the composition, the food or the beverage, and enhancement of mushroom flavor that are used in the method of the present invention are as described in the section “1. Composition for enhancing mushroom flavor.”

The time at which and the manner in which the composition of the present invention is added to the food or the beverage are not limited to a particular time or manner and the composition may be added in any manner at any time during the manufacturing process of the food or the beverage. The composition of the present invention may be added in an early step in manufacturing the food or the beverage and subsequently a step such as a heating step may be performed. Alternatively, the composition of the present invention may be added in a step near the end of manufacturing of the food or the beverage, for example, just before a living organism eats the food or the beverage.

3. Method for Manufacturing Food or Beverage that has Enhanced Mushroom Flavor

Furthermore, in one aspect, the present invention relates to a method for manufacturing a food or a beverage that has an enhanced mushroom flavor.

The definition and description of the composition, the food or the beverage, enhancement of mushroom flavor, and manufacturing a food or a beverage that are used in the manufacturing method of the present invention are as described in the sections “1. Composition for enhancing mushroom flavor” and “2. Method for enhancing mushroom flavor.”

4. Use for Enhancing Mushroom Flavor

Furthermore, in one aspect, the present invention relates to use of the composition of the present invention for enhancing mushroom flavor of a food or a beverage.

In one embodiment, the present invention relates to use of a composition comprising a nucleic acid comprising guanylic acid and adenylic acid for enhancing mushroom flavor of a food or a beverage.

In one embodiment, the present invention also relates to use of a composition comprising a nucleic acid comprising guanylic acid and adenylic acid and a free amino acid comprising glutamic acid and alanine for enhancing mushroom flavor of a food or a beverage.

In one embodiment, the present invention also relates to use of a composition comprising a nucleic acid comprising guanylic acid and adenylic acid, a free amino acid comprising glutamic acid and alanine, and succinic acid for enhancing mushroom flavor of a food or a beverage.

The definition and description of the composition of the present invention, the food or the beverage, and enhancement of mushroom flavor are as described in the sections “1. Composition for enhancing mushroom flavor” and “2. Method for enhancing mushroom flavor.”

### EXAMPLES

Hereinbelow, the present invention will be described in detail based on Examples, but the present invention is not limited by these Examples. One skilled in the art can readily make modifications and changes in the present invention based on the description of this specification and the modifications and changes are within the technical scope of the present invention.

### Example 1 Production of Yeast Extract with High Nucleic Acid Content

A suspension of a Saccharomyces cerevisiae FT-4 (FERM BP-8081) strain was centrifuged to recover cells and excessive ingredients of the culture medium were removed by washing the cells with water. These cells were suspended and then heat-treated to inactivate an enzyme in the cells. Then, the suspension was cooled down and pH-adjusted, followed by extraction of an extract. Residual cells were removed by centrifugation and the obtained supernatant was pH-adjusted, and then an enzyme was added to react with the supernatant. After completion of the reaction, the reaction solution was heated to inactivate the added enzyme, then was concentrated and spray-dried to obtain the yeast extract powder of the present invention.

### Example 2 Analysis of Ingredients Contained in Yeast Extract and Shiitake-Extracted Substance

Substances, that is, the yeast extract of the present invention (HIMAX (registered trademark) AG (manufactured by Fuji Foods Corporation)), which is one embodiment of the present invention, and a commercially available yeast extract (AROMILD (registered trademark) NT, manufactured by KOHJIN Life Sciences Co., Ltd.) were subjected to analysis of ingredients contained therein, which were an organic acid, a free amino acid, and a nucleic acid-related substance. Two kinds of shiitake-extracted substances (SAN-LIKE shiitake N (manufactured by San-Ei Gen F.F.I., Inc.) and shiitake extract powder NA (manufactured by Fuji Foods Corporation)) were also subjected to a similar analysis and the results were compared.

<Measurement Method>

(1) Method for measuring organic acid: A sample for measurement was prepared by centrifuging the substances after extraction with hot water and filtering the supernatant thus obtained through a 0.45 g filter, and the content of the organic acid was measured by a HPLC method. The parameters for HPLC are as follows:

Column: GL-C610H-S (Hitachi High-Technologies Corporation)

Column temperature: 56° C.

Eluent: 3 mM perchloric acid 0.5 ml/min

Reaction solution: 0.21% disodium hydrogenphosphate

0.00938% bromothymol blue

Detection: UV 430 nm

The measured value is represented as a concentration (%) based on the dry weight of the measured sample.

(2) Method for measuring amino acid: A sample for measurement was prepared by centrifuging the substances after extraction with hot water and filtering the supernatant thus obtained through a 0.20μ filter, and the content of the amino acid was measured by using an amino acid analyzer (Hitachi L-8900). Ninhydrin was used as a reaction solution.

The measured value is represented as a concentration (%) based on the dry weight of the samples.

(3) Method for measuring nucleic acid-related substance: A sample for measurement was prepared by centrifuging the substances after extraction with hot water and filtering the supernatant thus obtained through a 0.45 filter, and a content of the nucleic acid was measured by a HPLC method. The parameters for HPLC are as follows:

Column: Hitachi gel #3013-N, 3.0×150 mm

Column temperature: 70° C.

Detection: UV 254 nm

Mobile phase: phosphate buffer (NH₄Cl, KH₂PO₄, K₂HPO₄, acetonitrile)

The results are shown in Table 1-1 to Table 1-3 below.

Table 1 Analysis of ingredients contained in yeast extract of present invention, shiitake-extracted substance, and commercially available yeast extract

TABLE 1-1
Results of nucleic acid-related substances (mg/100 g)

| | 5′- | 5′- | 5′- | 5′- | 5′- |
|---|---|---|---|---|---|
| | CMP · | UMP · | AMP · | IMP · | GMP · |
| | 2Na | 2Na | 2Na | 2Na | 2Na |
| Yeast extract of | 5124 | 5988 | 7948 | 0 | 7507 |
| present invention | | | | | |
| SAN-LIKE | 0 | 0 | 0 | 0 | 4 |
| shiitake N | | | | | |
| Shiitake extract | 0 | 0 | 0 | 0 | 0 |
| powder NA | | | | | |
| Commercially | 5423 | 6277 | 8019 | 83 | 7619 |
| available yeast | | | | | |
| extract | | | | | |

Limit of detection 2 mg/100 g

TABLE 1-2

| | Analysis results of free amino acids (mg/100 g) | | | |
|---|---|---|---|---|
| | Yeast extract | | Shiitake | Commercially |
| | of present | SAN-LIKE | extract | available |
| | invention | shiitake N | powder NA | yeast extract |
| Tau | 0 | 0 | 0 | 0 |
| Asp | 389 | 36 | 30 | 246 |
| Thr | 266 | 43 | 40 | 122 |
| Ser | 287 | 42 | 38 | 123 |
| Glu | 9990 | 215 | 148 | 4382 |
| Gly | 218 | 17 | 14 | 113 |
| Ala | 3917 | 79 | 70 | 684 |
| Val | 334 | 63 | 58 | 125 |
| Cys | 14 | 3 | 0 | 51 |
| Met | 36 | 18 | 11 | 25 |
| Ile | 66 | 61 | 53 | 38 |
| Leu | 46 | 119 | 103 | 53 |
| Tyr | 29 | 27 | 11 | 40 |
| Phe | 41 | 72 | 62 | 48 |
| β-Ala | 5 | 0 | 0 | 25 |
| GABA | 53 | 42 | 39 | 24 |
| Orn | 720 | 13 | 0 | 87 |
| Lys | 79 | 65 | 52 | 141 |
| His | 49 | 7 | 0 | 133 |
| Ans | 0 | 0 | 0 | 0 |
| Car | 0 | 0 | 0 | 0 |
| Arg | 366 | 100 | 84 | 853 |
| Pro | 197 | 0 | 0 | 0 |
| Total | 17102 | 1022 | 813 | 7313 |

TABLE 1-3
Analysis results of organic acids (mg/100 g)

| | Phosphoric | Citric acid | DL-Malic | Succinic | DL-Lactic | Acetic | L-Pyroglutamic |
|---|---|---|---|---|---|---|---|
| | acid | monohydrate | acid | acid | acid | acid | acid |
| Yeast extract | 2812 | 292 | 71 | 1884 | 0 | 345 | 1458 |
| of present | | | | | | | |
| invention | | | | | | | |
| SAN-LIKE | 389 | 116 | 127 | 17 | 77 | 26 | 134 |
| shiitake N | | | | | | | |
| Shiitake | 371 | 74 | 109 | 35 | 91 | 31 | 180 |
| extract | | | | | | | |
| powder NA | | | | | | | |
| Commercially | 3080 | 0 | 80 | 321 | 654 | 107 | 844 |
| available | | | | | | | |
| yeast extract | | | | | | | |

As is shown in Table 1-1, the yeast extract of the present invention contains a similar amount of nucleic acid-related substances (CMP, UMP, AMP, and GMP) to the commercially available yeast extract. Furthermore, the yeast extract of the present invention does not contain IMP (inosinic acid) but the commercially available yeast extract contained a small amount of IMP. In contrast, as shown in Table 33 in Example 15 described below, it was revealed that two shiitake-extracted substances contained no or little nucleic acid ingredients although the shiitake-extracted substances had mushroom flavor by themselves. Since the above described two shiitake-extracted substances undergo a drying process, nucleic acid was presumably destroyed during the process, and furthermore, this result indicated that the shiitake-extracted substances produce the mushroom flavor from substances other than nucleic acid.

As described in Table 1-2, the yeast extract of the present invention contains glutamic acid (Glu), among free amino acids, at a concentration 46 or more times higher than the shiitake-extracted substances and 2.2 or more times higher than the commercially available yeast extract. And the yeast extract of the present invention contains alanine (Ala), at a concentration 49 or more times higher than the shiitake-extracted substances and 5.7 or more times higher than the commercially available yeast extract. As described in Table 1-3, the yeast extract of the present invention contains succinic acid, among organic acids, at a concentration 53 or more times higher than the shiitake-extracted substances and 5.8 or more times higher than the commercially available yeast extract.

### Example 3 Preparation of Mimic Liquid

In this Example, for analyzing the contribution of the ingredients in the yeast extract of the present invention obtained in Example 2 for production of taste, a mimic liquid was prepared based on the analysis result of the yeast extract by using preparations of the ingredients, that is, a nucleic acid, a free amino acid, and an organic acid, and was examined for taste thereof.

TABLE 2
Composition of mimic liquid
Nucleic acid (mg/100 g)

| | 5′- | 5′- | 5′- | 5′- |
|---|---|---|---|---|
| | CMP•2Na | UMP•2Na | AMP•2Na | GMP•2Na |
| Content | 5124 | 5988 | 7948 | 7507 |

Free amino acid mg/100 g

| | | | |
|---|---|---|---|
| Umami-type | Sweetness-type | Bitterness-type | Others |

| | | | | | | | |
|---|---|---|---|---|---|---|---|
| Glu | 9990 | Gly | 218 | Ile | 66 | GABA | 53 |
| Asp | 389 | Ala | 3917 | Leu | 46 | Orn | 720 |
| Total | 10379 | Thr | 266 | Phe | 41 | Cys | 14 |
| | | Ser | 287 | Arg | 366 | Total | 787 |
| | | Pro | 197 | His | 49 | | |
| | | Lys | 79 | Tyr | 29 | | |
| | | Total | 4964 | Val | 334 | | |
| | | | | Met | 36 | | |
| | | | | Total | 967 | | |

Organic acid (mg/100 g)

| | Phosphoric | Citric acid | DL-Malic | Succinic | DL-Lactic | Acetic | L-Pyroglutamic |
|---|---|---|---|---|---|---|---|
| | acid | monohydrate | acid | acid | acid | acid | acid |
| Analytical | 2812 | 292 | 71 | 1884 | 0 | 345 | 1458 |
| value | | | | | | | |

A solution in which the preparations were dissolved was used the mimic liquid. The concentration of the ingredients in the mimic liquid was set to the same concentration as those contained in the yeast extract with a high nucleic acid content of the present invention and the pH thereof was adjusted to 6.3, which was similar to pH of the yeast extract.

### Example 4 Potency Measurement of Yeast Extract and Mimic Liquid

In this Example, potency measurement of the yeast extract (HIMAX (registered trademark) AG (manufactured by Fuji Foods Corporation)) and the mimic liquid, which were one embodiment of the present invention, were performed.

(1) Potency Measurement of Yeast Extract of Present Invention

The yeast extract of the present invention was added to a solution of a shiitake-extracted substance to examine intensity of umami. Specifically, the yeast extract of the present invention was added at different concentrations indicated in Table 3 to 1.0% solution (% by volume) of the shiitake-extracted substance (Shiitake extract powder NA, manufactured by Fuji Foods Corporation) (hereinafter, the same was used as the shiitake-extracted substance in Examples, unless otherwise specified), and then, intensity of umami was examined by comparison to the 1.0, 1.25, 1.5, 1.75, and 2.0% solutions of the shiitake-extracted substance.

TABLE 3-1
Umami intensity of yeast extract of present invention

| Amount of yeast extract of present | Umami intensity |
|---|---|
| invention to be added (% by volume) | (% by volume) |
| 0.0025 | 1.00 |
| 0.0050 | 1.20 |
| 0.0075 | 1.35 |
| 0.0100 | 1.80 |
| 0.025 | 1.80 |
| 0.050 | 2% or more |

In Table 3-1, the umami intensity of 1.00 means that the umami intensity is equivalent to that of the 1.0% solution of the shiitake-extracted substance and there is no effect of enhancing umami. As is shown in Table 3-1, it was found that addition of the yeast extract of the present invention in an amount of 0.005% or more by volume led to increase in the umami intensity. Addition of the yeast extract of the mimic liquid in an amount of 0.025% by volume is as effective as the 1.8% solution of the shiitake-extracted substance.

(2) Potency Measurement of Mimic Liquid

In this Example, the potency measurement of the mimic liquid, which was one embodiment of the present invention, was performed.

The mimic liquid produced in Example 3 was added to the shiitake-extracted substance in an amount of 0.0025, 0.005, and 0.025% by weight to examine the intensity of umami by comparison to the 1.0, 1.15, and 1.80% solutions of the shiitake-extracted substance.

TABLE 3-2
Umami intensity of mimic liquid

| Amount of mimic liquid to | Umami intensity |
|---|---|
| be added (% by volume) | (% by volume) |
| 0.0025 | 1.00 |
| 0.0050 | 1.15 |
| 0.025 | 1.80 |

As is shown in Table 3-2, it was found that addition of the mimic liquid of Example 3 in an amount of 0.0050% or more by volume led to increase in the umami intensity. Addition of the mimic liquid in an amount of 0.025% by volume is as effective as the 1.8% solution of the shiitake-extracted substance. The effect of the mimic liquid on enhancing umami is almost the same as the effect of the yeast extract, and thus, it was presumed that the mimic liquid contained ingredients contributing to the effect.

(3) Potency Comparison Between Yeast Extract and Mimic Liquid

The intensity of a shiitake taste was examined when the yeast extract with a high nucleic acid content of the present invention and the mimic liquid of Example 3 were individually added to the shiitake-extracted substance.

Specifically, samples were prepared by adding the yeast extract with a high nucleic acid content or the mimic liquid of Example 3, each in an amount of 0.01% by volume, to the 1.0% solution of the shiitake-extracted substance (SAN-LIKE shiitake N, manufactured by San-Ei Gen F.F.I., Inc.). Then, the intensity of the shiitake taste of these samples was examined by comparison to the 1.0, 1.25, 1.5, 1.75, and 2.0% solutions of the shiitake-extracted substance.

Samples

Shiitake-extracted substances: 1.0, 1.25, 1.5, 1.75, and 2(%)

A group to which the yeast extract was added: the yeast extract was added in an amount of 0.01(%) to 1% shiitake-extracted substance

A group to which the mimic liquid was added: the mimic liquid was added in an amount of 0.01(%) to 1% shiitake-extracted substance

TABLE 3-3
Intensity of shiitake taste of yeast extract
of present invention and mimic liquid

| Added substances (addition | Equivalent shiitake- |
|---|---|
| in an amount of 0.01%) | extracted substance |
| Yeast extract of present invention | Equivalent to 1.8% |
| Mimic liquid | Equivalent to 1.5% |

Based on the result shown in Table 3-3, it is believed that the effect of the mimic liquid of Example 3 on enhancing shiitake flavor is about 80% of that of the yeast extract.

### Example 5 Examination of Ingredients in Yeast Extract that Contribute to Effect of Enhancing Shiitake Flavor

Furthermore, in this Example, mimic liquids of each ingredient were prepared to examine ingredients in the yeast extract that contributed to the effect of enhancing shiitake flavor.

First, a nucleic acid, an organic acid, and a free amino acid that were contained in the mimic liquid of the Example 3 were examined for the degree of contribution to the shiitake flavor. A 1% shiitake-extracted substance was set to a reference solution (score 0) and the score when the mimic liquids of all the groups were added each in an amount of 0.005% was set to 3, and the score when the mimic liquid of each group was added in an amount of 0.005% by volume was examined. The index for evaluation is as shown in Table 4 below and four professional panelists performed a sensory evaluation.

Evaluation Criteria

TABLE 4

| Evaluation | Criteria |
|---|---|
| −1 | A shitake taste is reduced or an unfavorable taste is sensed. |
| 0 | No effect |
| 1 | A shiitake taste is slightly enhanced |
| 2 | A shiitake taste is enhanced |
| 3 | A shiitake taste is greatly enhanced |

Regarding the degree of contribution to enhancement of shitake flavor by the ingredients contained in the mimic liquid, which are the nucleic acid, the organic acid, and the free amino acid (FAA), the evaluation results by the panelists are shown in Table 5 below.

TABLE 5
Degree of contribution to enhancement of shiitake
flavor by nucleic acid, organic acid, and free
amino acid (FAA) contained in mimic liquid

| | Panelists | | | | |
|---|---|---|---|---|---|
| Evaluated substances | (1) | (2) | (3) | (4) | Averaged score |
| Nucleic acid | 2 | 2 | 1 | 1 | 1.5 |
| Organic acid | 0 | 0 | 1 | 1 | 0.5 |
| FAA | 1 | 2 | 1 | 1 | 1.25 |
| Mimic liquid | 2 | 2 | 3 | 2 | 2.25 |

As is shown in Table 5, it was indicated that the main ingredient contributing to the shiitake flavor was the nucleic acid and additionally the free amino acid and the organic acid also contributed thereto.

### Example 6 Identification of Contributing Ingredients in Nucleic Acid Ingredients

Further, in this Example, the nucleic acid ingredients contained in the mimic liquid were further examined for the degree of contribution thereof to enhancement of shiitake flavor. A 1% solution of a shiitake-extracted substance was set to a reference solution (score 0) and the score when the mimic liquids of all kinds of nucleic acids (all the nucleic acids) were added thereto each in an amount of 0.005% by weight was set to 3, and the score when the mimic liquid of each nucleic acid (each nucleic acid) was added in an amount of 0.005% by volume was examined. The index for evaluation is as shown in Table 4 and four professional panelists performed a sensory evaluation. The results are shown in Table 6.

TABLE 6
Degree of contribution to shiitake flavor by each
nucleic acid ingredient contained in mimic liquid

| Evaluated substances | Averaged score |
|---|---|
| AMP | 1.00 |
| GMP | 2.13 |
| CMP | 0.00 |
| UMP | 0.00 |

When GMP was added, the shiitake flavor was strongly sensed. Therefore, GMP was confirmed to be a main contributing ingredient to enhancement of the shiitake flavor. When AMP was added, umami of the shiitake-extracted substance was sensed somewhat clearly. In this regard, taste was not sensed from AMP itself (alone).

### Example 7 Determination of Optimal Concentration of GMP to be Added to Shiitake-Extracted Substance

In this Example, an appropriate amount of GMP that was added to a shiitake-extracted substance for enhancing shiitake flavor was examined. GMP reagents at gradually-varied concentrations were added to a 1% solution of the shiitake-extracted substance and evaluation was performed. The index for evaluation is as shown in Table 7 below.

TABLE 7

| Evaluation | Criteria |
|---|---|
| ± | No effect |
| + | A shiitake savor is a little increased |
| ++ | A shiitake savor is increased |
| +++ | A shiitake savor is remarkably increased |
| Δ | A shiitake savor is increased but a different taste is also |
| | sensed |
| X | A taste different from shiitake is sensed |

The results are shown in Table 8.

TABLE 8
GMP concentrations and effect of enhancing shiitake flavor

| | GMP (% by weight) | | | | | | | | |
|---|---|---|---|---|---|---|---|---|---|
| | 0.00008 | 0.0004 | 0.0008 | 0.004 | 0.008 | 0.04 | 0.08 | 0.2 | 0.3 |
| E- | ± | ± | + | ++ | +++ | +++ | Δ | Δ | X |
| valu- | | | | | | | | | |
| ation | | | | | | | | | |

As is shown in Table 8, the effective range of GMP is as follows.

The effective range is about 0.0004% by weight or more and less than about 0.3% by weight,

preferably, about 0.0008% by weight to about 0.2% by weight,
more preferably, about 0.004% by weight to about 0.08% by weight,
and most preferably, about 0.008% by weight to about 0.04% by weight.

This is converted to the effective range of the yeast extract as follows.

The effective range is about 0.005% by volume or more and less than about 4% by volume,

preferably, about 0.01% by volume or more and less than about 3% by volume,
more preferably, about 0.05% by volume or more and less than about 1% by volume,
and most preferably, about 0.1% by volume or more and less than about 0.5% by volume.

### Example 8 Determination of Optimal Concentration of AMP to be Added to Shiitake-Extracted Substance+GMP

In this Example, an appropriate amount of AMP that was added to a shiitake-extracted substance+GMP (in the presence of GMP) for enhancing shiitake flavor was examined. AMP reagents at gradually-varied concentrations were added to a solution that was prepared by adding 0.0075% by weight of GMP to a 1% solution of the shiitake-extracted substance (equivalent to 0.1% by volume of GMP in the mimic liquid of Example 3), and evaluation was performed. The index for evaluation is as shown in Table 7.

It was revealed that the effect of enhancing shiitake flavor was increased when the shiitake-extracted substance+GMP was combined with AMP, when AMP at a threshold level was added to GMP, which was an ingredient enhancing the shiitake flavor. The effective range of AMP is as described in Table 9.

TABLE 9
AMP concentrations and effect of enhancing shiitake flavor
(in presence of GMP)

AMP (% by weigh)

| | 0.00008 | 0.0008 | 0.008 | 0.08 | 0.8 | 2 |
|---|---|---|---|---|---|---|
| Evaluation | ± | ± | + | +++ | Δ | X |

The effective range is about 0.0001% by weight or more and less than about 2% by weight,

preferably, about 0.0008% by weight to about 0.8% by weight,
and even more preferably, about 0.008% by weight to about 0.1% by weight, about 0.008% by weight to about 0.08% by weight, or about 0.06% by weight to about 0.1% by weight.

This is converted to the effective range of the yeast extract as follows.

The effective range: about 0.01% by volume or more and less than about 25% by volume,

preferably, about 0.01% by volume or more and less than about 10% by volume, and more preferably, about 0.1% by volume or more and less than about 1% by volume.

### Example 9 Sensory Evaluation of Taste-Producing Property of Nucleic Acid Ingredients

In this Example, the sensory evaluation of taste was performed on GMP or AMP alone, which were a nucleic acid ingredients, a combination of both GMP and AMP, and combinations thereof with a shiitake-extracted substance (SAN-LIKE shiitake N, manufactured by San-Ei Gen F.F.I., Inc.). The results are shown in Table 10 below.

TABLE 10
Sensory evaluation of taste-producing properties of nucleic acid ingredients

| | | | | | | | |
|---|---|---|---|---|---|---|---|
| Sensory | GMP | 0.008 | | 0.008 | 0.008 | | 0.008 |
| substances | AMP | | 0.08 | 0.08 | | 0.08 | 0.08 |
| (%) | SAN-LIKE | | | | 1.0 | 1.0 | 1.0 |
| | shiitake N | | | | | | |
| Evaluation | Intensity of taste | ◯ | ◯ | ◯ | ◯ | ◯ | ⊚ |
| | Comment | Umami is | Umami is | Umami is | A shiitake | A shiitake | A shiitake |
| | | slightly | slightly | slightly | flavor is | flavor is | flavor is |
| | | sensed | sensed | sensed | sensed | sensed | clearly |
| | | | | | | | sensed |

Table 10 indicates the following:
Umami was slightly sensed in the case of the 0.008% solution of GMP and the 0.08% solution of AMP. These concentrations are believed to be so-called threshold levels.
Then, both GMP and AMP were mixed at the lowest possible concentrations at which umami would be sensed (threshold levels) (in the absence of a shiitake-extracted substance). In this case, the taste became distinctive due to a little enhancement of a salty taste, which presumably resulted from increased sodium, but the taste itself was sensed only to the extent that each thereof was added and no shiitake flavor was sensed, either.
When each of GMP and AMP was further combined with the shiitake-extracted substance (SAN-LIKE shiitake N, manufactured by San-Ei Gen F.F.I., Inc.), it was found that the effect of enhancing shiitake flavor was clearly obtained.
When three ingredients, which were GMP, AMP, and the shiitake-extracted substance, were added, it was revealed that the effect of enhancing shiitake flavor was produced and the shiitake flavor was clearly sensed.

### Example 10 Determination of Optimal Concentrations of Glutamic Acid, Alanine, and Succinic Acid to be Added to Shiitake-Extracted Substance+GMP

In this Example, an appropriate amount to be added of each of glutamic acid (Glu) and alanine (Ala) as a free amino acid and succinic acid as an organic acid, which are added to a shiitake-extracted substance+GMP (in the presence of GMP) for enhancing shiitake flavor, was examined.

A solution prepared by adding 0.0075% by weight of GMP to a 1% solution of the shiitake-extracted substance (SAN-LIKE shiitake N, manufactured by San-Ei Gen F.F.I., Inc.) was used as a control, and mimic liquids of Glu, Ala, and succinic acid as shown in Table 11 were added in the respective amounts thereof described in Table 12 to Table 14 (in % by volume) and the presence or absence of the effect of enhancing shiitake flavor and effective ranges thereof were determined. The index for evaluation is as shown in Table 7.

TABLE 11
Preparation of mimic liquid

| | mg/100 g | % |
|---|---|---|
| Glu | 9990.0 | 9.9900 |
| Ala | 3917.0 | 3.9170 |
| Succinic acid | 1884.2 | 1.8842 |

Glu

TABLE 12
Glu

| | Mimic liquid (%) | | | | | | |
|---|---|---|---|---|---|---|---|
| | 0.0001 | 0.001 | 0.01 | 0.1 | 1.0 | 10.0 | 20.0 |
| Evaluation | ± | + | ++ | +++ | +++ | Δ | X |

The effective range is about 0.0001% by volume to about 20% by volume of the mimic liquid (Glu concentration: about 0.00001% by weight or more and less than about 2% by weight),

preferably, about 0.001% by volume to about 10% by volume of the mimic liquid (Glu concentration: about 0.0001% by weight to about 1% by weight),
and more preferably, about 0.01% by volume to about 1% by volume of the mimic liquid (Glu concentration: about 0.001% by weight to about 0.1% by weight).

Ala

TABLE 13
Ala

Mimic liquid (%)

| | 0.001 | 0.01 | 0.1 | 1.0 | 10.0 | 20.0 |
|---|---|---|---|---|---|---|
| Evaluation | ± | + | ++ | ++ | Δ | X |

The effective range is about 0.001% by volume to about 20% by volume of the mimic liquid (Ala concentration: about 0.00004% by weight or more and less than about 0.8% by weight);

preferably, about 0.01% by volume to about 10% by volume of the mimic liquid (Ala concentration: about 0.0004% by weight to about 0.4% by weight);
and more preferably, about 0.1% by volume to about 1% by volume of the mimic liquid (Ala concentration: about 0.004% by weight to about 0.04% by weight).

Succinic Acid

TABLE 14
Succinic acid

Mimic liquid (%)

| | 0.001 | 0.01 | 0.1 | 1.0 | 10.0 | 20.0 |
|---|---|---|---|---|---|---|
| Evaluation | ± | + | + | Δ | X | X |

The effective range is about 0.001% by volume to about 10% by volume of the mimic liquid (succinic acid concentration: about 0.00002% by weight or more and less than about 0.2% by weight), and preferably about 0.01% by volume to about 1% by volume of the mimic liquid (succinic acid concentration: about 0.0002% by weight to 0.02% by weight).

It was revealed that the shiitake flavor was enhanced by addition of glutamic acid and/or alanine to the shiitake-extracted substance+GMP. When only succinic acid was added to the shiitake-extracted substance+GMP, a shiitake savor was slightly enhanced.

### Example 11 Effect Produced when Other Various Free Amino Acids were Added to Shiitake-Extracted Substance+GMP

In this Example, various free amino acids other than Glu and Ala were added to a shiitake-extracted substance+GMP and the effect thereby was examined.

A solution prepared by adding 0.0075% by weight of GMP to a 1% solution of the shiitake-extracted substance (SAN-LIKE shiitake N, manufactured by San-Ei Gen F.F.I., Inc.) was used as a control. Mimic liquids (pH 6.3) of various kinds of free amino acids as shown in Table 15 were prepared and added in the respective amounts thereof described in Table 16 to Table 25 (in % by volume), and the presence or absence of the effect of enhancing shiitake flavor and effective ranges thereof were determined. The index for evaluation is as shown in Table 7.

### Mimic Liquids of Various Kinds of Free Amino Acids

TABLE 15

| Free amino acid | |
|---|---|
| Ile | 66 |
| Leu | 46 |
| Phe | 41 |
| Arg | 366 |
| Lys | 79 |
| His | 49 |
| Cys | 14 |
| Tyr | 29 |
| Val | 334 |
| Met | 36 |
| Total | 1060 |
| | mg/100 g |

TABLE 16
Ile

Mimic liquid (%)

| | 0.001 | 0.01 | 0.1 | 1.0 | 10.0 | 20.0 |
|---|---|---|---|---|---|---|
| Evaluation | ± | ± | ± | ± | ± | ± |

TABLE 17
Leu

Mimic liquid (%)

| | 0.001 | 0.01 | 0.1 | 1.0 | 10.0 | 20.0 |
|---|---|---|---|---|---|---|
| Evaluation | ± | ± | ± | ± | + | + |

TABLE 18
Phe

Mimic liquid (%)

| | 0.001 | 0.01 | 0.1 | 1.0 | 10.0 | 20.0 |
|---|---|---|---|---|---|---|
| Evaluation | ± | ± | + | + | + | + |

TABLE 19
Arg

Mimic liquid (%)

| | 0.001 | 0.01 | 0.1 | 1.0 | 10.0 | 20.0 |
|---|---|---|---|---|---|---|
| Evaluation | ± | + | + | + | ++ | ++ |

TABLE 20
Lys

Mimic liquid (%)

| | 0.001 | 0.01 | 0.1 | 1.0 | 10.0 | 20.0 |
|---|---|---|---|---|---|---|
| Evaluation | ± | ± | + | + | ++ | +++ |

TABLE 21
His

Mimic liquid (%)

| | 0.001 | 0.01 | 0.1 | 1.0 | 10.0 | 20.0 |
|---|---|---|---|---|---|---|
| Evaluation | ± | ± | ± | + | + | + |

TABLE 22
Cys

Mimic liquid (%)

| | 0.001 | 0.01 | 0.1 | 1.0 | 10.0 | 20.0 |
|---|---|---|---|---|---|---|
| Evaluation | + | + | ++ | +++ | Δ | X |

TABLE 23
Tyr

Mimic liquid (%)

| | 0.001 | 0.01 | 0.1 | 1.0 | 10.0 | 20.0 |
|---|---|---|---|---|---|---|
| Evaluation | ± | ± | ± | ++ | ++ | ++ |

TABLE 24
Val

Mimic liquid (%)

| | 0.001 | 0.01 | 0.1 | 1.0 | 10.0 | 20.0 |
|---|---|---|---|---|---|---|
| Evaluation | ± | ± | ± | ± | ± | ± |

TABLE 25
Met

Mimic liquid (%)

| | 0.001 | 0.01 | 0.1 | 1.0 | 10.0 | 20.0 |
|---|---|---|---|---|---|---|
| Evaluation | ± | ± | ± | ± | + | + |

As is shown in Table 16 to Table 25, the shiitake flavor was enhanced mainly when arginine, lysine, and cysteine were added. Other amino acids also slightly enhanced the shiitake flavor when they were added in a large quantity. Preferably, existence of these additional free amino acids in an appropriate amount is believed to have led to greater enhancement of the shiitake flavor.

### Example 12 Effect Produced when Liquid Mixture of GABA and Orn were Added to Shiitake-Extracted Substance+GMP

In this Example, a liquid mixture of GABA and ornithine (Orn) was added to a shiitake-extracted substance+GMP and the effect thereby was examined.

Liquid Mixture of GABA and Ornithine (Orn)

GABA 53 mg/100 g+Orn 720 mg/100 g

A solution prepared by adding 0.0075% by weight of GMP to a 1% solution of the shiitake-extracted substance (SAN-LIKE shiitake N, manufactured by San-Ei Gen F.F.I., Inc.) was used as a control. The liquid mixtures of GABA and ornithine (Orn) was added in the amounts described in Table 26 (in % by volume) and the presence or absence of the effect of enhancing shiitake flavor and effective range thereof were determined. The index for evaluation is as shown in Table 7.

TABLE 26
GABA + Orn

Mimic liquid (%)

| | 0.001 | 0.01 | 0.1 | 1.0 | 10.0 | 20.0 |
|---|---|---|---|---|---|---|
| Evaluation | ± | ± | ± | ± | ± | ± |

As is shown in Table 26, no difference was seen between the liquid mixture of GABA and Orn and the control regardless of the amount of the liquid mixture added. It was revealed that GABA and ornithine were not involved for the effect of enhancing shiitake flavor.

### Example 13 Effect of Enhancing Mushroom Flavor Produced when GABA and AMP were Added to Various Substances Extracted from Mushrooms

In this Example, GABA and AMP were added to various substances extracted from mushrooms and the effects of enhancing mushroom flavor thereby were evaluated.

Mushroom Samples

(1) A dried shiitake (Donko produced in Oita)
(2) A fresh shiitake (lion shiitake produced in Hokkaido)
(3) A fresh button mushroom (brown button mushroom produced in Chiba)
(4) A dried porcino (TENTAZIONI produced in Italy)

Method for Preparing Mushroom-Extracted Substances

Extracted substances from mushroom samples (1) to (4) were prepared as described below.

For (1), 1 little of water was added to 30 g of dried shiitakes, extracted for 24 hours at 5° C., and filtered.

For (2) and (3), water was added in an amount three times the weight of the chopped mushrooms, heated for 10 minutes at 60° C., and filtered.

For (4), 1 L of water was added to 50 g of dried porcini, extracted for 4 hours at room temperature, and filtered. All the obtained mushroom-extracted liquids were adjusted to Brix 0.8.

Sensory Test Method

A control group and a group in which a GMP reagent liquid and an AMP reagent liquid were added (both equivalent to 0.1% by volume of the mimic liquid of Example 3) were formed for each of the mushroom-extracted substances, and these groups were subjected to a sensory test and the presence or absence of the effect was examined. (four panelists)

TABLE 27
Number of panelists who felt that the mushroom savor was strong

| Sample | Control | Test group |
|---|---|---|
| (1) Dried shiitake | 0 | 4 |
| (2) Fresh shiitake | 1 | 3 |
| (3) Fresh mushroom | 0 | 4 |
| (4) Dried porcino | 1 | 3 |

As is shown in Table 27, for all the mushroom-extracted substances (1) to (4), it was evaluated that the group in which GMP and AMP were added (test group) had a more enhanced mushroom flavor than the control group. It was revealed that GMP and AMP had an action that enhanced various mushroom flavors.

### Example 14 Effect of Enhancing Mushroom Flavor when GMP, AMP, Glu, Ala, and Succinic Acid were Added to Various Substances Extracted from Mushrooms

In this Example, effects of enhancing mushroom flavor when GMP, AMP, Glu, Ala, and succinic acid were added to various substances extracted from mushrooms were evaluated.

Preparation of mushroom samples and mushroom-extracted substances was performed as in Example 13.

Sensory Test Method

The following samples were prepared for each of the mushroom-extracted substances.

TABLE 28
Sample

| | |
|---|---|
| A | Control |
| B | Group in which GMP and AMP were added |
| C | Group in which GMP, AMP, Glu, Ala, and |
| | succinic acid were added |

Each amount of the substances to be added is equivalent to the amount contained in 0.1% of the mimic liquid described in Example 3, and thus, each amount is equivalent to the amount in % by weight as described below.

GMP 0.0075% by weight

AMP 0.0079% by weight

Glu 0.01% by weight

Ala 0.0039% by weight

Succinic acid 0.0019% by weight

Four professional panelists performed the sensory test and ranked the samples according to the intensity of mushroom savor. A sample having the strongest mushroom savor was rated as 2, a sample having the second strongest one as 1, and a sample having the third strongest one as 0. The results are shown in Table 29 to Table 32.

TABLE 29
(1) Dried shiitake

Panelists

| Sample | (1) | (2) | (3) | (4) |
|---|---|---|---|---|
| A | 0 | 0 | 1 | 0 |
| B | 1 | 1 | 0 | 1 |
| C | 2 | 2 | 2 | 2 |

All the four panelists answered that C had the strongest shiitake taste. Furthermore, three panelists answered that A, the control, had the weakest shiitake taste and one panelist answered that B had the weakest shiitake taste.

TABLE 30
(2) Fresh shiitake

Panelists

| Sample | (1) | (2) | (3) | (4) |
|---|---|---|---|---|
| A | 0 | 0 | 1 | 0 |
| B | 1 | 1 | 0 | 1 |
| C | 2 | 2 | 2 | 2 |

All the four panelists answered that C had the strongest shiitake taste. Furthermore, three panelists answered that A had the weakest shiitake taste and one panelist answered that B had the weakest shiitake taste.

TABLE 31
(3) Fresh button mushroom

Panelists

| Sample | (1) | (2) | (3) | (4) |
|---|---|---|---|---|
| A | 0 | 0 | 1 | 0 |
| B | 1 | 1 | 0 | 1 |
| C | 2 | 2 | 2 | 2 |

All the four panelists answered that C had the strongest button mushroom taste. Furthermore, three panelists answered that A had the weakest mushroom taste and one panelist answered that B had the weakest button mushroom taste.

TABLE 32
(4) Dried porcino

Panelists

| Sample | (1) | (2) | (3) | (4) |
|---|---|---|---|---|
| A | 0 | 0 | 0 | 0 |
| B | 1 | 2 | 1 | 1 |
| C | 2 | 1 | 2 | 2 |

Three panelists answered that C had the strongest porcino taste and one panelist answered that B had the strongest porcino taste. Furthermore, all the four panelists answered that A had the weakest porcino taste.

As described above, it was revealed that a mushroom flavor-enhancing action was further increased when Glu, Ala, and succinic acid were used concurrently along with addition of GMP and AMP.

### Example 15 Test of Ingredients Having Mushroom Flavor-Enhancing Action for Taste Produced Thereby in Absence of Mushroom-Extracted Substance

In this Example, a test of ingredients having a mushroom flavor-enhancing action for a taste produced thereby in absence of a mushroom-extracted substance was performed.

A sensory analysis was performed on the samples shown in Table 33.

TABLE 33

| | Components | | | | | | | | | |
|---|---|---|---|---|---|---|---|---|---|---|
| | Shiitake | Yeast | | | | | | | | |
| | extract | extract or | Commercially | | | | | | | |
| | powder | present | available yeast | | | | | Succinic | | Intensity |
| Sample | NA | invention | extract | GMP | AMP | Glu | Ala | acid | | of flavor |
| Shiitake extract | 1% | | | | | | | | | ⊚ |
| powder NA | | | | | | | | | | |
| Yeast extract of | | 0.1 | | | | | | | | ⊚ |
| present invention | | | | | | | | | | |
| Commercially | | | 0.1 | | | | | | | ◯ |
| available yeast extract | | | | | | | | | | |
| GMP | | | | 0.008 | | | | | * | Δ |
| AMP | | | | | 0.008 | | | | * | Δ |
| GMP + AMP | | | | 0.008 | 0.008 | | | | * | Δ |
| Glu alone | | | | | | 0.01 | | | * | Δ |
| Ala alone | | | | | | | 0.004 | | * | Δ |
| Succinic acid alone | | | | | | | | 0.002 | * | Δ |
| GMP + AMP + Glu + | | | | 0.008 | 0.008 | 0.01 | 0.004 | 0.002 | * | ◯ |
| Ala + succinic acid | | | | | | | | | | |
| Mimic liquid (nucleic | | | | | | | | | ** | ◯ |
| acid, amino acid, and | | | | | | | | | | |
| organic acid) | | | | | | | | | | |

| | Mushroom savor | | |
|---|---|---|---|
| Sample | Evaluation | Comment | Results of sensory analysis |
| Shiitake extract | ◯ | There was | From the viewpoint of quality of taste, a complicated taste is |
| powder NA | | mushroom savor | sensed in which bitterness, astringency, and the like are combined |
| | | | in addition to umami and sweetness. From the view of change |
| | | | in taste over time, umami stands out during the period from so |
| | | | called middle taste to so called aftertaste. |
| Yeast extract of | X | There was no | Among various mixed tastes, umami is sensed outstandingly. |
| present invention | | mushroom savor | Although aftertaste is similar to that of a shiitake-extracted |
| | | | substance, the taste from initial period to middle period is |
| | | | different and bitterness and astringency different from those of |
| | | | shiitake are sensed. |
| Commercially | X | There was no | Umami is sensed gradually during the period from middle taste to |
| available yeast extract | | mushroom savor | aftertaste. Generally taste is weaker than that of the yeast |
| | | | extract of the present invention and produced taste is similar to |
| | | | that of the combination of reagents AMP and GMP. |
| GMP | X | There was no | Gradual umami during the period from middle taste to aftertaste. |
| | | mushroom savor | |
| AMP | X | There was no | Almost no taste but extremely slight taste like sweetness or |
| | | mushroom savor | umami. |
| GMP + AMP | X | There was no | Umami during the period from middle taste to aftertaste. |
| | | mushroom savor | Umami is clearer than that of GMP alone. |
| Glu alone | X | There was no | Slight umami. |
| | | mushroom savor | |
| Ala alone | X | There was no | Almost no taste but extremely slight sweetness is sensed. |
| | | mushroom savor | |
| Succinic acid alone | X | There was no | Both umami and harsh after taste are sensed. |
| | | mushroom savor | |
| GMP + AMP + Glu + | X | There was no | Taste similar to shiitake is sensed during the period from middle |
| Ala + succinic acid | | mushroom savor | taste to aftertaste but a complicated taste lacks. |
| Mimic liquid (nucleic | X | There was no | Almost the same as the result of GMP + AMP + Glu + Ala + |
| acid, amino acid, and | | mushroom savor | succinic acid. |
| organic acid) | | | |

*: Each ingredient was added in an amount contained in 0.1% solution of a yeast extract.
**: See the composition of the mimic liquid in Table 2.

When the mushroom-extracted substance was not added, neither the yeast extract with a high nucleic acid content of the present invention (HIMAX (registered trademark) AG (manufactured by Fuji Foods Corporation)), GMP+AMP, a liquid mixture of GMP+AMP+Glu+Ala+succinic acid, nor the mimic liquid produced mushroom flavor. It was revealed that the effect observed in Examples 4 to 14 was the effect of “enhancing” a coexisting mushroom flavor and not the effect of inducing mushroom flavor that was originally inexistent. In particular, AMP, Glu, and Ala hardly produce any taste on their own.

### Example 16 Comparison of Effect of Enhancing Shiitake Flavor Between Yeast Extract of Present Invention and Known Yeast Extract

In this Example, an effect of yeast extracts on enhancing shiitake flavor was compared between a yeast extract with a high nucleic acid content (HIMAX (registered trademark) AG (manufactured by Fuji Foods Corporation)), which was one embodiment of the present invention, and a commercially available yeast extract (AROMILD (registered trademark) NT, manufactured by KOHJIN Life Sciences Co., Ltd.).

Method

A. A 0.3% by volume of solution of each yeast extract was prepared.
B. Each yeast extract was added in an amount of 0.01% by volume to a 1% solution of SAN-LIKE shiitake N (manufactured by San-Ei Gen F.F.I., Inc.) and comparison was performed.

Results

A. The yeast extract of the present invention: in addition to umami derived from nucleic acid, astringency, umami, and the like are sensed from the moment of putting the yeast extract in the mouth.
Commercially available yeast extract: umami with an aftertaste that appears to derive from nucleic acid is sensed but there is not much taste other than that.
B. The yeast extract of the present invention: an impression is given that the shiitake flavor is generally enhanced from the moment of putting the yeast extract in the mouth through to the aftertaste.
Commercially available yeast extract: an impression that the aftertaste has a slightly enhanced shiitake flavor is given but the enhancing effect is weak.

### INDUSTRIAL APPLICABILITY

The composition of the present invention exerts a mushroom flavor-enhancing effect synergistically when the composition is added to a food or a beverage comprising a mushroom or a mushroom-extracted substance. Use of the composition of the present invention allows for enhancing mushroom flavor conveniently and inexpensively without increasing the amount of the mushroom or the mushroom-extracted substance to be used. For example, when a yeast extract is used as the composition of the present invention, yeasts can be cultured more quickly, more inexpensively, and in a smaller space than when mushrooms are grown.

1. A composition for enhancing mushroom flavor, comprising a nucleic acid comprising guanylic acid and adenylic acid.

2. A composition for enhancing mushroom flavor, comprising a nucleic acid comprising guanylic acid and adenylic acid and a free amino acid comprising glutamic acid and alanine.

3. A composition for enhancing mushroom flavor, comprising a nucleic acid comprising guanylic acid and adenylic acid, a free amino acid comprising glutamic acid and alanine, and succinic acid.

4. The composition for enhancing mushroom flavor according to claim 1, wherein the composition is a yeast extract.

5. The composition for enhancing mushroom flavor according to claim 1, wherein the composition comprises a nucleic acid comprising 0.0004% by weight or more and less than 0.3% by weight of guanylic acid and 0.0001% by weight or more and less than 2% by weight of adenylic acid.

6. The composition for enhancing mushroom flavor according to claim 2, wherein the composition comprises a free amino acid comprising 0.00001% by weight or more and less than 2% by weight of glutamic acid and 0.00004% by weight or more and less than 0.8% by weight of alanine.

7. The composition for enhancing mushroom flavor according to claim 3, wherein the composition comprises 0.00002% by weight or more and less than 0.2% by weight of succinic acid.

8. The composition for enhancing mushroom flavor according to claim 1, wherein the mushroom is selected from the edible mushroom group consisting of a shiitake (Lentinula edodes), button mushroom (Agaricus bisporus), porcino (Boletus spp.), enoki mushroom (Flammulina velutipes), white beech mushroom (Hypsizygus marmoreus), hon-shimeji (Lyophyllum shimeji), king oyster mushroom (Pleurotus eryngii), oyster mushroom (Pleurotus ostreatus), pine mushroom (Tricholoma matsutake), truffle (Tuber), and butterscotch mushroom (Pholiota microspora).

9. The composition for enhancing mushroom flavor according to claim 1, wherein the mushroom is selected from the edible mushroom group consisting of shiitake (Lentinula edodes), white button mushroom (Agaricus bisporus), and porcino (Boletus spp.).

10. The composition for enhancing mushroom flavor according to claim 1, wherein the free amino acid further comprises one or more free amino acids selected from the group consisting of arginine, lysine, and cysteine.

11. A method for enhancing mushroom flavor, comprising adding a composition comprising a nucleic acid comprising guanylic acid and adenylic acid to a food or a beverage that comprises a mushroom or a mushroom-extracted substance.

12. A method for enhancing mushroom flavor, comprising adding a composition comprising a nucleic acid comprising guanylic acid and adenylic acid and a free amino acid comprising glutamic acid and alanine to a food or a beverage that comprises a mushroom or a mushroom-extracted substance.

13. A method for enhancing mushroom flavor comprising adding a composition comprising a nucleic acid comprising guanylic acid and adenylic acid, a free amino acid comprising glutamic acid and alanine, and succinic acid to a food or a beverage that comprises a mushroom or a mushroom-extracted substance.

14. The method according to claim 11, wherein the composition is a yeast extract.

15. The method according to claim 11, wherein the composition comprises a nucleic acid comprising 0.0004% by weight or more and less than 0.3% by weight of guanylic acid and 0.0001% by weight or more and less than 2% by weight of adenylic acid.

16. A method for manufacturing a food or a beverage that has an enhanced mushroom flavor, the method comprising adding a composition comprising a nucleic acid comprising guanylic acid and adenylic acid to a food or a beverage that comprises a mushroom or a mushroom-extracted substance.

17. Use of a composition comprising a nucleic acid comprising guanylic acid and adenylic acid for enhancing mushroom flavor of a food or a beverage.

18. The composition for enhancing mushroom flavor according to claim 2, wherein the composition is a yeast extract.

19. The composition for enhancing mushroom flavor according to claim 3, wherein the composition is a yeast extract.

20. The composition for enhancing mushroom flavor according to claim 2, wherein the composition comprises a nucleic acid comprising 0.0004% by weight or more and less than 0.3% by weight of guanylic acid and 0.0001% by weight or more and less than 2% by weight of adenylic acid.
